(19) United States
(12) Patent Application Publication
(10) Pub. No.: US 2025/0360886 A1
(43) Pub. Date: Nov. 27, 2025

(54) ELECTRONIC CONTROL DEVICE AND COMMUNICATION NETWORK SYSTEM

(71) Applicant: TOYOTA JIDOSHA KABUSHIKI KAISHA, Toyota-shi (JP)

(72) Inventors: Yuta MURAKAMI, Toyota-shi (JP); Masaki Wasekura, Toyota-shi (JP)

(73) Assignee: TOYOTA JIDOSHA KABUSHIKI KAISHA, Toyota-shi (JP)

(21) Appl. No.: 19/033,893

(22) Filed: Jan. 22, 2025

(30) Foreign Application Priority Data
May 27, 2024 (JP) 2024-085601

(51) Int. Cl. B60R 16/023; H04L 9/40; H04L 12/40

(52) U.S. Cl. CPC B60R 16/0231; H04L 12/40006; H04L 63/08; H04L 2012/40273

(57) ABSTRACT

The first device, which is an electronic control device, is communicably connected to a providing-side electronic control device in a communication network system to which a plurality of electronic control devices mounted on a vehicle are connected. The providing-side electronic control device transmits information to another electronic control device in the communication network system at a predetermined cycle. Each time the first device is activated, the first device resets parameters necessary for realizing a specific function based on the received information. The first device transmits, at the time of activation, a shortening notification requesting that information be transmitted in a cycle shorter than a predetermined cycle to the providing-side electronic control device. The first device authenticates the received information based on the information received from the providing-side electronic control device a plurality of times, and sets a parameter based on the information that has been authenticated.

### CROSS-REFERENCE TO RELATED APPLICATION

This application claims priority to Japanese Patent Application No. 2024-085601 filed on May 27, 2024, incorporated herein by reference in its entirety.

### BACKGROUND

### 1. Technical Field

The present disclosure relates to an electronic control device and a communication network system.

### 2. Description of Related Art

Japanese Unexamined Patent Application Publication No. 2008-222052 (JP 2008-222052 A) describes a communication network system. The communication network system is composed of a plurality of electronic control devices mounted on a vehicle and capable of communicating with each other.

Among the electronic control devices included in the communication network system, there are provides a providing-side electronic control device that transmits information and a receiving-side electronic control device that receives the transmitted information. The receiving-side electronic control device sets a parameter for implementing a specific function based on the received information.

### SUMMARY

In order to be able to quickly implement the specific function, it is desirable that the receiving-side electronic control device should be able to quickly acquire information from the providing-side electronic control device and quickly complete the setting of the parameter.

In order to address the above issue, an aspect provides
an electronic control device communicably connected to a providing-side electronic control device in a communication network system to which a plurality of electronic control devices mounted on a vehicle is connected.

The providing-side electronic control device transmits information at a predetermined cycle to other electronic control devices in the communication network system.

The electronic control device resets a parameter necessary to implement a specific function based on the information at each startup

The electronic control device transmits a shortening notification to request transmission of the information at a cycle shorter than the predetermined cycle to the providing-side electronic control device at startup.

The electronic control device executes authentication of the received information based on the information received from the providing-side electronic control device a plurality of times.

The electronic control device sets the parameter based on the information of which the authentication has been completed.

In order to address the above issue, an aspect provides a communication network system to which a plurality of electronic control devices mounted on a vehicle is connected.

The communication network system includes a providing-side electronic control device that transmits information to other electronic control devices in the communication network system at a predetermined cycle.

The communication network system includes a receiving-side electronic control device communicably connected to the providing-side electronic control device, the receiving-side electronic control device resetting a parameter necessary to implement a specific function based on the information at each startup.

In the communication network system,
the receiving-side electronic control device transmits a shortening notification to request transmission of the information at a cycle shorter than the predetermined cycle to the providing-side electronic control device at startup.

In the communication network system,
the receiving-side electronic control device executes authentication of the received information based on the information received from the providing-side electronic control device a plurality of times.

In the communication network system, the receiving-side electronic control device sets the parameter based on the information of which the authentication has been completed.

In the communication network system,
the providing-side electronic control device transmits the information at a cycle shorter than the predetermined cycle when the shortening notification is received.

The electronic control device described above can reduce the time required to receive information and complete the setting of the parameter. In addition, the communication network system described above allows the receiving-side electronic control device to execute authentication of information quickly, and therefore makes it possible to reduce the time required for the receiving-side electronic control device to complete the setting of the parameter.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a communication network system according to an embodiment;

FIG. 2 is a sequential diagram illustrating a mode in which the activated first device receives vehicle information from the providing-side electronic control device in the communication network system of FIG. 1; and

FIG. 3 is a sequence diagram illustrating a mode in which a first device sets parameters in the communication network system of FIG. 1.

### DETAILED DESCRIPTION OF EMBODIMENTS

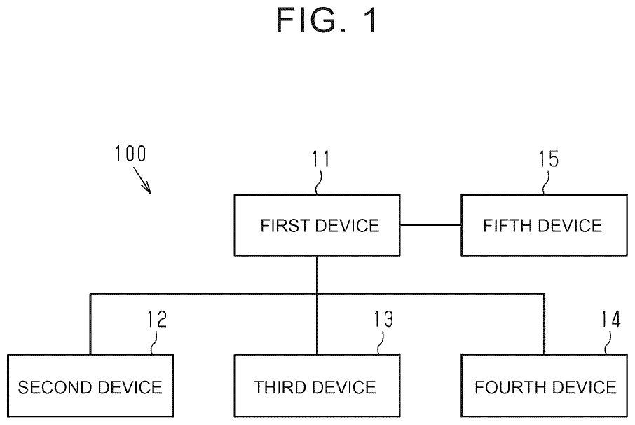

Hereinafter, an embodiment of an electronic control device will be described with reference to FIGS. 1 to 3.

A configuration of the communication network system 100 will be described.

The communication network system 100 is mounted on a vehicle. As shown in FIG. 1, in a communication network system 100, a plurality of electronic control devices is connected. In FIG. 1, the electronic control device included in the communication network system 100 is represented by a square. Each of the plurality of electronic control devices implements a specific function in the vehicle.

As illustrated in FIG. 1, the communication network system 100 includes a first device 11, a second device 12, a third device 13, a fourth device 14, and a fifth device 15. As shown in FIG. 1, the first device 11, the second device 12, the third device 13, and the fourth device 14 are communicably connected to each other. As shown in FIG. 1, the first device 11 and the fifth device 15 are communicably connected to each other. In the communication network system 100, the electronic control device is in Controller Area Network (CAN) communication with other electronic control devices. The communication protocol used by the electronic control device in the communication network system 100 is not limited to CAN communication.

The communication network system 100 includes a providing-side electronic control device. The providing-side electronic control device transmits information to other electronic control devices in the communication network system 100 at predetermined intervals. The second device 12, the third device 13, and the fourth device 14 are providing-side electronic control devices. The second device 12, the third device 13, and the fourth device 14 individually define a period for transmitting information.

In the communication network system 100, the second device 12, the third device 13, and the fourth device 14, which are providing-side electronic control devices, transmit vehicle information to other electronic control devices at predetermined intervals. The vehicle information is information related to a vehicle on which the communication network system 100 is mounted. For example, the providing-side electronic control device transmits, as vehicle information, information indicating a type of a component of the vehicle, such as an engine or a tire. For example, the providing-side electronic control device transmits information on the weight of the vehicle as vehicle information. For example, the providing-side electronic control device transmits, as vehicle information, information on the size of the vehicle. The types of vehicle information transmitted by the second device 12, the third device 13, and the fourth device 14 are different from each other.

The communication network system 100 comprises a receiving-side electronic control device. The receiving-side electronic control device is communicatively coupled to the providing-side electronic control device. The first device 11 is a receiving-side electronic control device. In the communication network system 100, the first device 11 is, for example, an electronic control device that controls automatic driving by the vehicle.

The first device 11 implements a plurality of specific functions. For example, the first device 11 controls steering so that the vehicle under autonomous driving can travel within the frame of the lane. Further, the first device 11 controls braking in the vehicle during automatic driving.

The first device 11, which is the receiving-side electronic control device, resets parameters necessary for realizing a specific function based on the information received from the providing-side electronic control device each time it is activated. A mode of control executed by the first device 11 to realize a specific function is changed by setting a parameter in accordance with the content of vehicle information to be received. For example, when the information on the size of the vehicle is received as the vehicle information from the providing-side electronic control device, the first device 11 adjusts the turning angle of the steering at the time of right and left turn in accordance with the size of the vehicle indicated by the vehicle information.

The first device 11 patterns and stores a mode for realizing a specific function according to the content of the vehicle information to be received. For example, the first device 11 stores the mode of steering control from the first pattern to the Nth pattern, and selects a pattern corresponding to the size of the vehicle indicated by the vehicle information. In the example of the steering control described above, the parameter setting is to set a variable for the size of the vehicle necessary for selecting an appropriate pattern.

The first device 11 is communicatively connected to a plurality of providing-side electronic control devices. Specifically, the first device 11 is communicably connected to three providing-side electronic control devices, namely, the second device 12, the third device 13, and the fourth device 14.

When receiving the vehicle information from the providing-side electronic control device, the first device 11 sets parameters for a specific function corresponding to the type of the received vehicle information. For example, the first device 11 sets a parameter related to the steering control during the automatic driving when the vehicle size information is received as the vehicle information from the second device 12. Further, the first device 11 receives the information on the weight of the vehicle as the vehicle information from the third device 13, and sets the parameter related to the steering control during the automatic driving when the information on the type of the tire included in the vehicle is received from the fourth device 14.

The first device 11 periodically receives the vehicle information from the second device 12, the third device 13, and the fourth device 14 even while the specific function is being realized after the setting of the parameter is completed.

The communication network system 100 comprises a dependent electronic control device. In the communication network system 100, a dependent electronic control device is connected to the first device 11, which is the receiving-side electronic control device. The dependent electronic control device receives the parameters set by the receiving-side electronic control device from the receiving-side electronic control device each time it is activated, and reapplies them to itself.

The fifth device 15 is a dependent electronic control device. In the communication network system 100, the fifth device 15 receives the parameter set by the first device 11 every time it is activated, and applies the parameter to itself again. As a result, the fifth device 15 performs control in a manner corresponding to the applied parameter.

In the communication network system 100, the fifth device 15 is, for example, an electronic control device that assists the first device 11 in controlling the vehicle during automatic driving. For example, the fifth device 15 executes image processing of an image captured by a camera included in the vehicle. Then, the first device 11 executes the control of the vehicle based on the result of the image processing by the fifth device 15. The number of cameras mounted on the vehicle and the mounting position of the cameras differ depending on the size of the vehicle. Therefore, the fifth device 15 needs to execute image processing corresponding to the size of the vehicle. Then, a parameter is received from the first device 11, and the parameter is applied. As a result, the fifth device 15 can execute the image processing corresponding to the size of the vehicle.

Mode of Communication when the First Device 11 is Activated

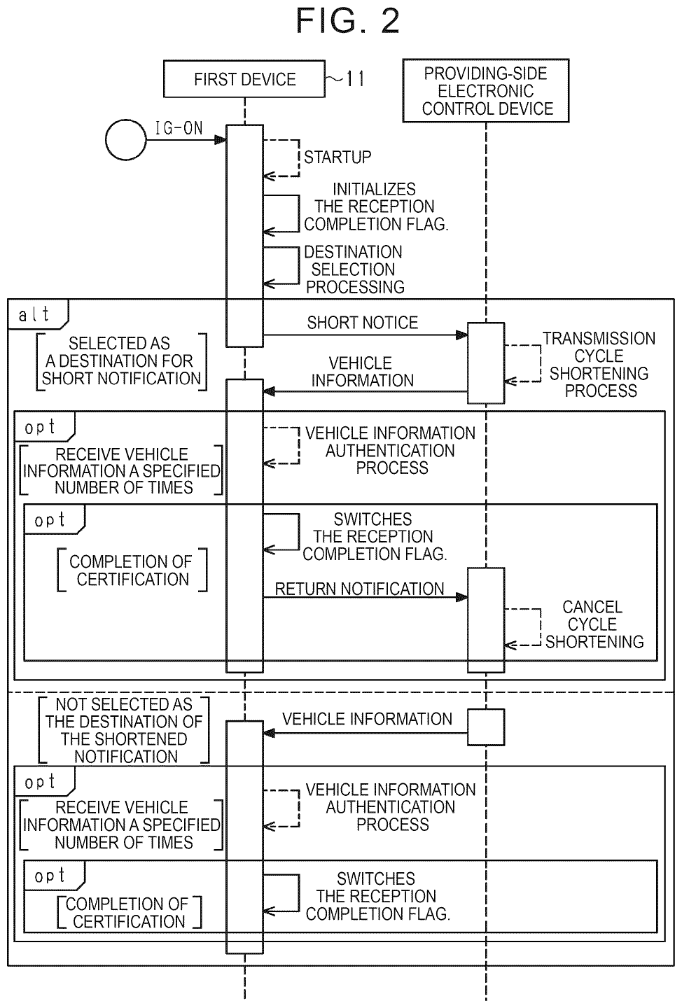

FIG. 2 shows a mode of communication performed between the first device 11 and the providing-side electronic control device when the first device 11 is activated. The first device 11 communicates with each of the second device 12, the third device 13, and the fourth device 14 in the manner shown in FIG. 2.

As shown in the upper part of FIG. 2, the first device 11 is activated when the ignition switch of the vehicle is switched and the ignition is turned IG-ON.

As illustrated in the upper part of FIG. 2, the first device 11 initializes the reception completion flag after being activated. As will be described later, after receiving the information from the providing-side electronic control device, the first device 11 can use the information for setting the parameter when the authentication of the received information is completed. The reception completion flag is a flag indicating whether or not information is received from the providing-side electronic control device and the received information is available for setting a parameter. The first device 11 manages a reception completion flag for each of communication with the second device 12, communication with the third device 13, and communication with the fourth device 14.

The state in which the reception completion flag is initialized refers to a state in which the reception completion flag indicates zero. When the reception completion flag indicates zero, the reception completion flag indicates that the first device 11 is not in an available state for setting a parameter with respect to the information transmitted by the providing-side electronic control device. For example, when the vehicle information is not received from the second device 12 after the first device 11 is activated, the reception completion flag for communication with the second device 12 is set to zero. Even when the authentication of the information received from the second device 12 is not completed, the reception completion flag for the communication with the second device 12 is set to zero.

The first device 11 receives the information from the providing-side electronic control device, and switches the reception completion flag from zero to one when the received information becomes available for setting the parameter. Specifically, when the vehicle information is received from the second device 12 after the first device 11 is activated and the authentication of the received information is completed, the reception completion flag for the second device 12 is set to 1.

Mode of Communication when the First Device 11 Executes the Transmission Destination Selection Process

As illustrated in the upper part of FIG. 2, the first device 11 initializes the reception completion flag and then executes the transmission destination selection process. In the transmission destination selection process, the first device 11 selects the providing-side electronic control device that is the transmission destination of the shortening notification. The shortening notification is a notification requesting the providing-side electronic control device to transmit information in a cycle shorter than a predetermined cycle.

As described above, the second device 12, the third device 13, and the fourth device 14, which are the providing-side electronic control devices, individually define a period in which information is transmitted. Some of the providing-side electronic control devices may not be able to shorten the period in which information is transmitted even if the shortening notification is received. For example, when there is a possibility that the transmitted vehicle information collides with a message transmitted by another electronic control device when the period in which the providing-side electronic control device transmits the vehicle information is shortened, the period in which the information is transmitted cannot be shortened.

In the transmission destination selection process, the first device 11 selects, from among the plurality of providing-side electronic control devices, a providing-side electronic control device capable of transmitting information in a cycle shorter than a predetermined cycle in each of the providing-side electronic control devices. The first device 11 stores data about the providing-side electronic control device that has a margin to shorten the period of transmitting the vehicle information among the second device 12, the third device 13, and the fourth device 14. In the transmission destination selection process, the first device 11 refers to the data to select the providing-side electronic control device that is the transmission destination of the shortening notification.

As illustrated in FIG. 2, in the transmission destination selection process, the mode of communication changes depending on whether or not the providing-side electronic control device of the communication partner is selected as the transmission destination of the shortening notification. The middle part of FIG. 2 illustrates a mode of communication when the providing-side electronic control device of the communication partner is selected as the transmission destination of the shortening notification. On the other hand, the lower part of FIG. 2 shows a communication mode in which the providing-side electronic control device of the communication partner is not selected as the transmission destination of the shortening notification.

As illustrated in the middle part of FIG. 2, when the providing-side electronic control device of the communication partner is selected as the transmission destination of the shortening notification, the first device 11 transmits the shortening notification to the providing-side electronic control device. On the other hand, as shown in the lower part of FIG. 2, when the providing-side electronic control device of the communication partner is not selected as the transmission destination of the shortening notification, the shortening notification is not transmitted.

As described above, the first device 11 transmits the shortening notification to the providing-side electronic control device at the time of activation. At this time, the first device 11 selects the providing-side electronic control device that transmits the shortening notification, and then transmits the shortening notification to the selected providing-side electronic control device.

As illustrated in the middle part of FIG. 2, the providing-side electronic control device that has received the shortening notification from the first device 11 executes the transmission cycle shortening process. In the transmission cycle shortening process, the providing-side electronic control device shortens the cycle for transmitting the vehicle information.

In the providing-side electronic control device capable of shortening the period for transmitting information, in addition to the period of the normal state in which the shortening notification is not received, a period for corresponding to the shortening notification is predetermined. The period for responding to the shortened notification is shorter than the period of the normal state. The cycle for responding to the shortening notification is determined individually for each providing-side electronic control device as in the cycle of the normal state.

The providing-side electronic control device capable of shortening the period for transmitting the information stores a period for corresponding to the shortening notification in addition to the period of the normal state in which the shortening notification is not received. In the transmission cycle shortening process, the providing-side electronic control device switches the cycle for transmitting the vehicle information from the cycle of the normal state to the cycle for corresponding to the shortening notification.

In the middle stage of FIG. 2, the providing-side electronic control device executes the transmission cycle shortening process, and then transmits the vehicle information in a cycle for corresponding to the shortening notification. In this way, when receiving the shortening notification, the providing-side electronic control device transmits the information in a cycle shorter than a predetermined cycle.

As shown in the lower part of FIG. 2, in a case where the transmission destination of the shortening notification is not selected in the transmission destination selection process, since the shortening notification is not transmitted, the cycle for transmitting the vehicle information is not shortened. Therefore, in the lower part of FIG. 2, the providing-side electronic control device that is not selected as the transmission destination of the shortening notification transmits the vehicle information in the cycle of the normal state.

Mode of Communication when the First Device 11 Authenticates Vehicle Information

As illustrated in the middle and lower stages of FIG. 2, the first device 11 executes the vehicle information authentication process when the vehicle information is received a predetermined number of times from the providing-side electronic control device after the activation. The vehicle information authentication process is executed regardless of whether or not the vehicle information authentication process is selected as the transmission destination of the shortening notification. The predetermined number of times is a value equal to or greater than 2.

In the vehicle information authentication process, the first device 11 performs authentication of the vehicle information received from the providing-side electronic control device. The first device 11 executes vehicle information authentication processing for each of the second device 12, the third device 13, and the fourth device 14, which are providing-side electronic control devices. For example, when vehicle information is received a predetermined number of times from the second device 12, the first device 11 executes vehicle information authentication processing on the second device 12. The predetermined number of times may be determined uniformly for all the providing-side electronic control devices, or may be determined for each providing-side electronic control device.

In the vehicle information authentication process, the first device 11 performs authentication of the received information based on the information received from the providing-side electronic control device a plurality of times. For example, the first device 11 checks whether all the vehicle information received from the providing-side electronic control device a plurality of times is the same. Then, when confirming that the vehicle information received a plurality of times is the same, the first device 11 authenticates the vehicle information on the assumption that the received vehicle information is normally transmitted.

As illustrated in the middle and lower stages of FIG. 2, the first device 11 executes the vehicle information authentication process, and after the authentication of the vehicle information is completed, switches the reception completion flag for the providing-side electronic control device that has transmitted the vehicle information for which the authentication has been completed from zero to one. This process is executed regardless of whether or not the vehicle information authentication process is selected as the transmission destination of the shortening notification.

As illustrated in the middle part of FIG. 2, after switching the reception completion flag, the first device 11 transmits a return notification to the providing-side electronic control device corresponding to the reception completion flag. The return notification is a notification requesting that the period at which the providing-side electronic control device transmits information be returned to a predetermined period. After the completion of the authentication, the first device 11 transmits a return notification to the providing-side electronic control device that has transmitted the information for which the authentication has been completed. As shown in the lower part of FIG. 2, the return notification is not transmitted to the providing-side electronic control device that has not received the shortening notification.

As illustrated in the middle part of FIG. 2, the providing-side electronic control device that has received the return notification cancels the shortening of the cycle in which the vehicle information is transmitted. At this time, the providing-side electronic control device switches the cycle for transmitting the vehicle information from the cycle for responding to the shortening notification to the cycle of the normal state.

Mode of Communication when the First Device 11 Sets a Parameter

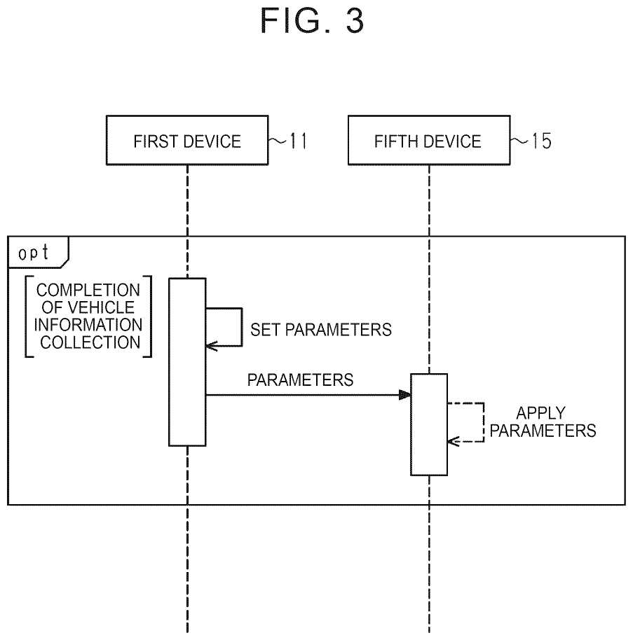

FIG. 3 illustrates an aspect of communication between the first device 11 and the fifth device 15 when the first device 11 sets a parameter based on vehicle information.

As illustrated in FIG. 3, the first device 11 sets the parameter when the collection of the vehicle information is completed. As described above, when the vehicle information is received, the first device 11 sets a parameter for a specific function corresponding to the received vehicle information. The first device 11 determines that the collection of the vehicle information is completed when the reception completion flag for all the providing-side electronic control devices that transmit the vehicle information necessary for realizing the specific function is switched from zero to one. For example, when the reception completion flag for the second device 12 that transmits the vehicle information indicating the size of the vehicle is switched from zero to one, the first device 11 determines that the collection of the vehicle information for the steering control during the automatic driving is completed. As described above, the first device 11 and the fifth device 15 perform communication in the manner shown in FIG. 3 for each specific function realized by the first device 11.

As illustrated in FIG. 3, the first device 11 sets parameters by selecting a pattern of a mode for realizing a specific function in accordance with the contents of vehicle information. At this time, the first device 11 sets a parameter for a specific function corresponding to the type of vehicle information that has been collected. In this way, the first device 11 sets the parameter based on the information that the authentication has been completed.

As illustrated in FIG. 3, after the setting of the parameter is completed, the first device 11 transmits the set parameter to the fifth device 15 that is the dependent electronic control device. Then, the fifth device 15 that has received the parameter applies the received parameter to itself.

### Operations of Present Embodiment

The first device 11, which is an electronic control device, shortens the period in which the providing-side electronic control device transmits information, thereby increasing the frequency of receiving information.

### Effects of Present Embodiment

(1) The first device 11, which is an electronic control device, can receive information and shorten the time required for completing the setting of the parameter.

(2) The first device 11, which is an electronic control device, is communicably connected to a plurality of providing-side electronic control devices. The first device 11 selects, from among the plurality of providing-side electronic control devices, a providing-side electronic control device capable of transmitting information in a cycle shorter than a predetermined cycle in each of the providing-side electronic control devices. The first device 11 transmits the shortening notification to the selected providing-side electronic control device.

Some of the providing-side electronic control devices may not be able to shorten the period in which the information is transmitted even if the shortening notification is received. The first device 11, which is an electronic control device, selects a providing-side electronic control device that can shorten a cycle from among the providing-side electronic control devices, and transmits a shortening notification. As a result, the first device 11 can prevent the transmission of the shortening notification to the providing-side electronic control device that cannot shorten the cycle, and thus can reduce the amount of communication in the communication network system 100.

(3) After the authentication is completed, the first device 11, which is an electronic control device, transmits a return notification requesting the providing-side electronic control device that has transmitted the information for which the authentication is completed to return the period for transmitting the information to a predetermined period.

The first device 11, which is an electronic control device, transmits a return notification to the providing-side electronic control device that has transmitted the information for which authentication has been completed. As a result, the first device 11 can cause the providing-side electronic control device to return to the shortened cycle. After the setting of the parameter is completed, the frequency of transmission of the vehicle information can be reduced to suppress the amount of communication.

(4) In the communication network system 100, the first device 11, which is an electronic control device, is connected with a dependent electronic control device that receives, from the first device 11, a parameter set by the first device 11 every time it is activated, and reapplies to the dependent electronic control device. After the parameter setting is completed, the first device 11 transmits the set parameter to the dependent electronic control device.

In the communication network system 100, the dependent electronic control device applies the parameters set by the first device 11, which is the electronic control device, to itself. The first device 11 can quickly set the parameter by the shortening notification. Therefore, the first device 11 can shorten the time until the application of the parameter by the dependent electronic control device.

(5) The communication network system 100 shortens the period in which the providing-side electronic control device transmits information, so that the receiving-side electronic control device can receive information quickly. Accordingly, the communication network system 100 can cause the receiving-side electronic control device to perform the authentication of the information quickly, and thus can shorten the time required for the receiving-side electronic control device to complete the setting of the parameter.

### Modifications

The present embodiment can be realized with the following modifications. The present embodiment and the following modifications can be combined with each other within a technically consistent range to be realized.

In the above-described communication network system 100, the providing-side electronic control device periodically transmits vehicle information. The information periodically transmitted by the providing-side electronic control device is not limited to the vehicle information. For example, the providing-side electronic control device may periodically transmit the position information, and the receiving-side electronic control device may determine the country based on the position information and set the parameter based on the determined country information.

The number of the receiving-side electronic control device, the providing-side electronic control device, and the dependent electronic control device included in the communication network system 100 is not limited to the above-described embodiment. For example, in the communication network system 100, the receiving-side electronic control device may be connected to a plurality of dependent electronic control devices.

The topology of the communication network system 100 is not limited to the above-described embodiment. For example, the dependent electronic control device may be directly connected to the providing-side electronic control device in a communicable manner.

In the above-described communication network system 100, in addition to activating and setting a parameter, the receiving-side electronic control device sets a parameter and then receives vehicle information from the providing-side electronic control device even while realizing a specific function.

The receiving-side electronic control device may not receive vehicle information from the providing-side electronic control device while implementing a particular function. That is, for example, the receiving-side electronic control device may receive the vehicle information only when the parameter is set, and the providing-side electronic control device may transmit the vehicle information to the electronic control device other than the receiving-side electronic control device at a timing other than when the receiving-side electronic control device is activated.

In the above-described communication network system 100, the first device 11 can realize a plurality of specific functions. Then, the first device 11 receives the vehicle information from the plurality of providing-side electronic control devices, and sets a parameter for a specific function corresponding to the type of the received vehicle information.

On the other hand, the first device 11 may be an electronic control device that realizes only one specific function. In this case, the first device 11 sets parameters for one specific function based on the vehicle information received from all the connected providing-side electronic control devices.

In the above-described communication network system 100, the providing-side electronic control device that has received the shortening notification shortens the period for transmitting the vehicle information by switching to a predetermined period for corresponding to the shortening notification. On the other hand, the manner in which the providing-side electronic control device that has received the shortening notification shortens the period is not limited to the above-described embodiment. For example, the providing-side electronic control device may shorten the cycle by receiving a notification indicating the cycle after the shortening at the same time as the shortening notification and applying the cycle indicated by the notification.

In the above-described communication network system 100, the types of vehicle information transmitted by the second device 12, the third device 13, and the fourth device 14 are different from each other. On the other hand, the types of vehicle information transmitted by the second device 12, the third device 13, and the fourth device 14 may be the same.

In the above communication network system 100, the receiving-side electronic control device is communicatively coupled to a plurality of providing-side electronic control devices. Meanwhile, the receiving-side electronic control device may be communicatively connected to one providing-side electronic control device.

In the above-described communication network system 100, the receiving-side electronic control device selects the providing-side electronic control device that is the transmission destination of the shortening notification, and then transmits the shortening notification to the selected providing-side electronic control device. The receiving-side electronic control device does not have to select the providing-side electronic control device to which the shortening notification is to be transmitted. For example, the receiving-side electronic control device may transmit the shortening notification to all the providing-side electronic control devices without selecting the transmission destination of the shortening notification.

In the above-described communication network system 100, after the authentication of the vehicle information is completed, the receiving-side electronic control device transmits a return notification to the providing-side electronic control device. The receiving-side electronic control device may not transmit the return notification.

The communication network system 100 described above comprises a dependent electronic control device. Communication network system 100 may not include a dependent electronic control device.

What is claimed is:

1. An electronic control device communicably connected to a providing-side electronic control device in a communication network system to which a plurality of electronic control devices mounted on a vehicle is connected, the providing-side electronic control device transmitting information at a predetermined cycle to other electronic control devices in the communication network system, and the electronic control device resetting a parameter necessary to implement a specific function based on the information at each startup, the electronic control device being configured to:
transmit a shortening notification to request transmission of the information at a cycle shorter than the predetermined cycle to the providing-side electronic control device at startup;
execute authentication of the received information based on the information received from the providing-side electronic control device a plurality of times; and
set the parameter based on the information of which the authentication has been completed.

2. The electronic control device according to claim 1, being configured to:
be communicatively connected to a plurality of providing-side electronic control devices;
select, from among the providing-side electronic control devices, a providing-side electronic control device capable of transmitting the information at a cycle shorter than the predetermined cycle in each of the providing-side electronic control devices; and
transmit the shortening notification to the selected providing-side electronic control device.

3. The electronic control device according to claim 1, being configured to transmit a return notification to request return of the cycle to transmit the information to the predetermined cycle to the providing-side electronic control device having transmitted the information of which the authentication has been completed after the authentication is completed.

4. The electronic control device according to claim 1, wherein:
a dependent electronic control device is connected in the communication network system, the dependent electronic control device receiving the parameter set by the electronic control device at each startup from the electronic control device and applying the parameter again to the dependent electronic control device itself; and
the electronic control device transmits the set parameter to the dependent electronic control device after completion of setting of the parameter.

5. A communication network system to which a plurality of electronic control devices mounted on a vehicle is connected, the communication network system comprising:
a providing-side electronic control device that transmits information to other electronic control devices in the communication network system at a predetermined cycle; and
a receiving-side electronic control device communicably connected to the providing-side electronic control device, the receiving-side electronic control device resetting a parameter necessary to implement a specific function based on the information at each startup, wherein:
the receiving-side electronic control device is configured to
transmit a shortening notification to request transmission of the information at a cycle shorter than the predetermined cycle to the providing-side electronic control device at startup,
execute authentication of the received information based on the information received from the providing-side electronic control device a plurality of times, and
set the parameter based on the information of which the authentication has been completed; and
the providing-side electronic control device is configured to transmit the information at a cycle shorter than the predetermined cycle when the shortening notification is received.
